(19) United States
(12) Patent Application Publication
(10) Pub. No.: US 2007/0000124 A1
(43) Pub. Date: Jan. 4, 2007

(54) Terminal feeding device for a termination machine

(75) Inventors: James Thomas Shandersky, Harrisburg, PA (US); Michael Morris, Harrisburg, PA (US); Neil Edward Deming, Lewisberry, PA (US)

Correspondence Address: Lisa B. Vaccarelli;Tyco Electronics Corporation, Suite 140, 4550 New Linden Hill Road, Wilmington, DE, 19808-2952, US

(73) Assignee: Tyco Electronics Corporation

(21) Appl. No.: 11/449,970

(22) Filed: Jun. 8, 2006

Related U.S. Application Data
(60) Provisional application No. 60/695,476, filed on Jun. 30, 2005.

(51) Int. Cl. H01R 43/00

(52) U.S. Cl. 29/748; 29/857

(57) ABSTRACT

A terminal crimping machine includes an applicator having crimp tooling configured to crimp a terminal to a wire in a crimping zone and an applicator motor driving the crimp tooling to and from the crimping zone. The machine also includes a feeder device positioned adjacent to the applicator, wherein the feeder device has a terminal feeding member configured to successively feed terminals to the crimping zone. A feeder motor drives the terminal feeding member in a terminal feeding direction and in a retracting direction, wherein the terminals are fed to the crimping zone as the terminal feeding member is moved in the terminal feeding direction.

### CROSS REFERENCE TO RELATED APPLICATIONS

This application claims priority to U.S. Provisional Application Ser. No. 60/695,476, filed Jun. 30, 2005, which is hereby incorporated by reference in its entirety.

### BACKGROUND OF THE INVENTION

This invention relates to terminal crimping machines, and more specifically, to motor controlled feeder devices for terminal crimping machines.

Current terminal crimping machines use a mechanical feeder device to feed strip-carried, tape carried, or end-to-end electrical connectors/terminals to crimp tooling of an applicator. Significant time and effort is required by machine operators to make adjustments to the feed stroke and/or position of the feeder device with respect to the crimp-tooling. These adjustments must be made when a different sized terminal is to be used. Additionally, these adjustments may be required during a crimping run.

In current feeder devices, the cam and linkage mechanisms are mechanically linked to the crimping process, thus the current connector/terminal feeder devices operate at a rate relative to the rate of the crimping process. Thus rapid feeding, and the tolerance and clearance stack up associated with multiple mechanical linkage components, causes variation in the terminal placement which in turn causes variation in the crimping process and crimp performance. Consequently, in order to prevent feed problems, the operator may slow the terminal feed speed which in turn slows the production rate.

### BRIEF DESCRIPTION OF THE INVENTION

In one aspect, a feeder device configured to be used with a termination machine having a termination tool is provided, wherein the device includes a frame configured to be located proximate to a termination zone of the termination tool and a feeder carriage slidable mounted to the frame. The feeder carriage is movable in a terminal feeding direction to an advanced position. An electric actuator is mounted to the frame and joined to the feeder carriage. The actuator drives the feeder carriage in the terminal feeding direction to the advanced position to locate a terminal at the termination zone.

Optionally, the feeder device may include a terminal feeding member engaging either a terminal or a carrier strip for a terminal A lead screw may be coupled to the actuator and threadably coupled to the feeder carriage such that, as the actuator rotates the lead screw, the feeder carriage moves linearly along the terminal feeding direction.

In another aspect, a termination machine is provided including a termination tool having termination tooling configured to terminate a terminal to a wire in a termination zone and a terminator actuator driving the termination tooling to and from the termination zone. The machine also includes a feeder device positioned adjacent to the termination tool, wherein the feeder device has a terminal feeding member configured to successively feed terminals to the crimping zone. An electric feeder actuator drives the terminal feeding member in a terminal feeding direction, wherein the terminals are fed to the termination zone as the terminal feeding member is moved in the terminal feeding direction.

In a further aspect, a termination system is provided including a termination tool having termination tooling configured to terminate a terminal to a wire in a termination zone, and a feeder device positioned proximate to the termination tool. The feeder device includes a frame, a feeder carriage slidable mounted to the frame, and an electric feeder actuator mounted to the frame and joined to the feeder carriage. The feeder motor drives the feeder carriage in a terminal feeding direction to an advanced position to locate a terminal at the termination zone.

Optionally, the feeder device may include a bracket to removably couple the feeder device to the termination tool. A control module may be provided for coordinating the operation of the termination actuator and the feeder actuator. Additionally, the feeder actuator may move the terminal feeding member along a controlled motion profile.

In yet another aspect, a termination machine is provided including a termination tool having termination tooling configured to terminate a terminal to a wire in a termination zone by driving the termination tooling to and from the termination zone. The termination tool is configured to receive terminals from a programmable feeder device having a feeder actuator driving a terminal feeding member in a terminal feeding direction, wherein the terminals are fed to the termination zone as the terminal feeding member is moved in the terminal feeding direction.

### BRIEF DESCRIPTION OF THE DRAWINGS

FIG. 1 illustrates a perspective view of a terminal crimping machine formed in accordance with an exemplary embodiment of the present invention.

FIG. 2 illustrates a perspective view of an applicator and a feeder device for the terminal crimping machine shown in FIG. 1.

FIG. 3 illustrates another perspective view of the applicator and the feeder device shown in FIG. 2.

FIG. 4 illustrates a perspective view of the feeder device for the machine shown in FIG. 1 with a cover removed.

FIG. 5 illustrates a cross sectional view of the applicator and the feeder device.

FIG. 6 illustrates a perspective view of the applicator and the feeder device.

FIG. 7 illustrates an exemplary terminal feeding member assembly for the feeder device.

FIG. 8 illustrates another exemplary terminal feeding member assembly for the feeder device.

FIG. 9 illustrates a perspective view of the feeder device in a retracted position.

FIG. 10 illustrates a perspective view of the feeder device in an advanced position.

### DETAILED DESCRIPTION OF THE INVENTION

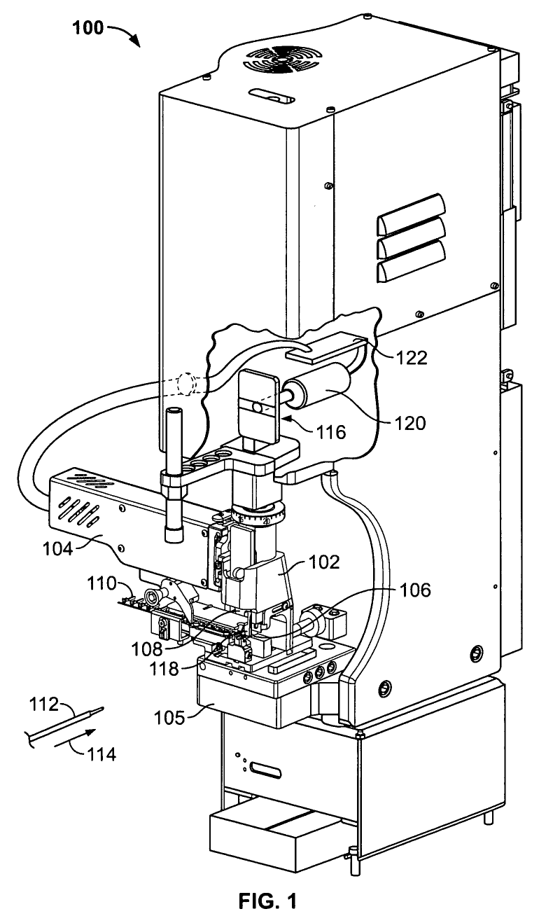

FIG. 1 illustrates a perspective view of a termination machine or terminator 100 having a termination tool 102 with terminating tooling and a feeder device 104. The terminator 100 is illustrated as a terminal crimping machine used for crimping connectors to wires, however, other types of terminators 100 may be used, such as, an IDC machine, a welding machine, and the like that attach connectors to wires using processes other than crimping, or the terminator 100 may be another type of crimping machine such as a lead frame machine. The termination tool 102 is illustrated and described hereinafter as an applicator 102.

The applicator 102 is coupled to a frame 105 of the terminator 100. The applicator 102 may be removed and replaced with a different applicator, such as when the applicator 102 is worn or damaged or when an applicator having a different configuration is desired. The applicator 102 has a terminating zone or crimping zone 106 and includes crimp-tooling 108 for crimping electrical connectors or terminals 110 to an end of a wire 112 in the crimping zone 106. The feeder device 104 is positioned to feed terminals accurately to the applicator 102 and presents the terminals 110 to the crimping zone 106. Optionally, the feeder device 104 may be positioned adjacent to, or even coupled to, the applicator 102. Alternatively, the feeder device 104 may be positioned remote with respect to the applicator 102, but still delivers the terminals 110 to the crimping zone 106. The terminals 110 may be guided to the crimp zone 106 by a guide member (not shown) to ensure proper positioning of the terminals 110 within the crimping zone 106. The wires 112 are delivered to the crimping zone 106 by a wire feeder (not shown) or a bench machine (not shown) in a wire loading direction 114.

The feeder device 104 may be configured to deliver, and the applicator 102 may be configured to receive, multiple sized terminals for crimping. The feeder device 104 may be configured to deliver either side-feed terminals or end-feed terminals. Side-feed terminals are arranged side-by-side on a carrier strip and end-feed terminals are arranged successively, end-to-end. The terminator 100 is configured to receive applicators 102 for either type of terminal, namely the side-feed or the end-feed terminals. Thus a first type of applicator 102 may be configured to receive side-feed terminals and a second type of applicator 102 may be configured to receive end-feed terminals. The side-feed and end feed types of applicators 102 may be interchanged with the terminator 100. A side-feed type applicator 102 is illustrated in FIG. 1.

During operation, the crimp-tooling 108 is driven through a crimp stroke by a driving mechanism 116 of the terminator 100 toward a stationary anvil 118. The crimp stroke has both a downward component and an upward component. The crimping of the terminal 110 to the wire 112 occurs during the downward component of the crimp stroke. The driving mechanism 116 is driven by a terminator actuator 120. Optionally, the terminator actuator 120 may be a motor having a drive shaft that moves driving mechanism 116. Alternatively, the terminator actuator 120 may be a linear actuator, a piezoelectric actuator, a pneumatic actuator, and the like. The operation of the terminator actuator 120 is controlled by a control module 122.

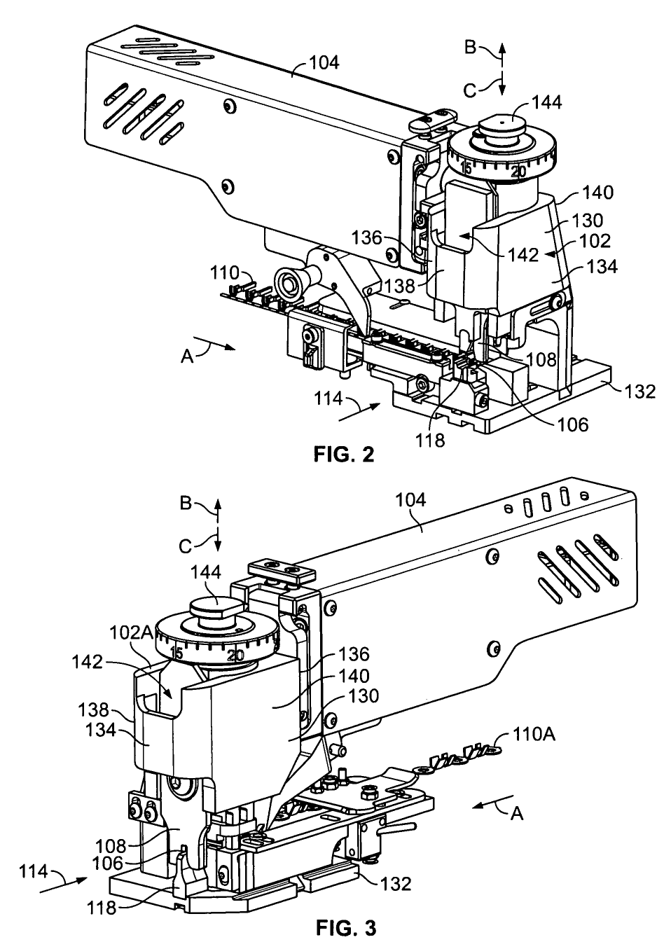

FIG. 2 illustrates a perspective view of a side-feed type applicator 102 and the feeder device 104. The feeder device 104 is positioned adjacent to the applicator 102 and presents side-feed terminals 110 to the crimping zone 106 of the applicator 102. FIG. 3 illustrates a perspective view of an end-feed type applicator 102A and the feeder device 104. The applicator 102A is similar to the applicator 102 shown in FIG. 2. As such, like reference numerals are used to identify like features.

The applicator 102 includes a frame 130 having a base 132. The anvil 118 is coupled to the base 132. The frame 130 includes a front 134, a rear 136, a side 138, a side 140, and a central cavity 142. The feeder device 104 is positioned adjacent to the rear 136 and the terminals 110 are carried or advanced in a feed direction from the rear 136 toward the front 134, such as in the feed direction of arrow A. Optionally, the terminals 110 may be presented along the side 138. The sides 138 and 140 extend generally parallel to the feed direction of the terminals 110. A ram 144 is received within the central cavity 142 and is movable with respect to the frame 130. The crimp-tooling 108 is coupled to the ram 144 and is positioned adjacent to the side 138. The ram 144 is coupled to the driving mechanism 116 (shown in FIG. 1) of the terminator 100 (shown in FIG. 1). The driving mechanism 116 moves the ram 144 vertically in a lifting or reset direction, shown by arrow B, generally away from the anvil 118 and a crimping direction, shown by arrow C, generally toward the anvil 118. The feeding of the terminals 110 and the driving of the ram 144 are coordinated. For example, as the ram 144 is moved in the lifting direction, the terminals 110 are advanced in the feed direction by the feeder device 104. Optionally, the terminals 110 may also be advanced while the ram 144 is moved in the crimping direction. The terminals 110 are located in the crimping zone 106 and are stationary as the crimp-tooling nears the crimping zone 106.

Turning to FIG. 3, the feeder device 104 is positioned adjacent to the applicator 102A and presents end-feed terminals 110A to the crimping zone 106 of the applicator 102A. The end-feed terminals are stacked end-to-end and fed to a central portion of the rear 136 of the applicator 102A, generally equidistant from the sides 138 and 140. The crimp-tooling 108 is also centrally located between the sides 138 and 140.

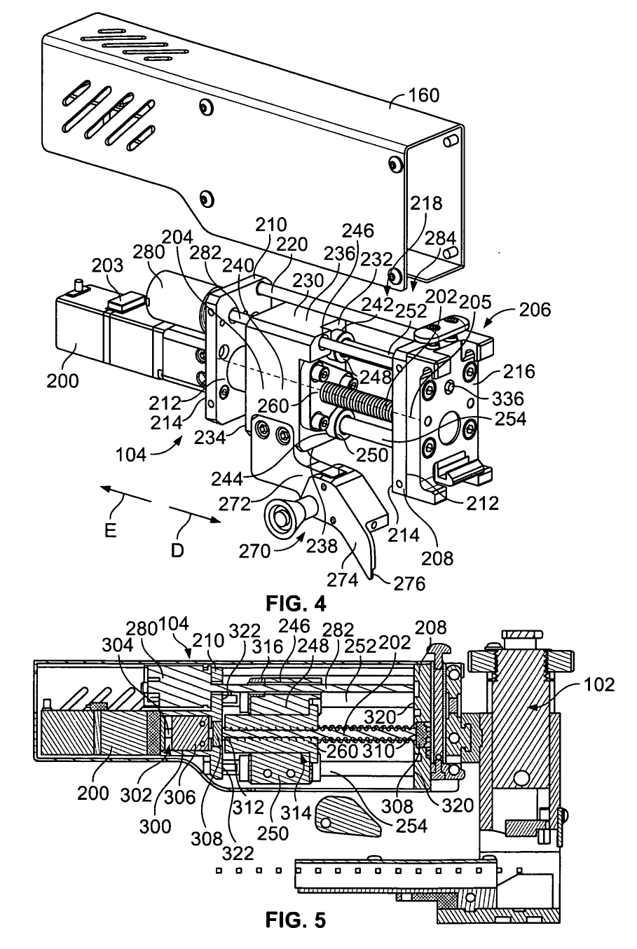

FIG. 4 illustrates a perspective view of the feeder device 104 with a cover 160 removed. The feeder device 104 may be separately provided from the applicator 102 (shown in FIGS. 1-3) and removably coupled to the applicator 102. Optionally, the feeder device 104 may be permanently coupled to the applicator 102. Alternatively, the feeder device 104 may be coupled to a portion of the frame 105 (shown in FIG. 1) of the terminator 100 (shown in FIG. 1).

The feeder device 104 includes a feeder actuator 200 joined to a lead screw 202 and a feeder carriage 204 also coupled to the lead screw 202. Alternatively, the feeder device 104 may include a ball screw or another type of driving mechanism in place of the lead screw 202. In the illustrated embodiment, the feeder actuator 200 is a servo motor. Alternatively, the feeder actuator 200 may be a stepper motor, or another type of actuator such as, for example, a linear actuator, a pneumatic actuator, a piezoelectric actuator or motor, and the like. The feeder actuator 200 includes a controller 203 for controlling the operation of the feeder actuator 200. The controller 203 may communicate with the control module 122 (shown in FIG. 1) to coordinate the operation of the feeder actuator 200 with the operation of the driving mechanism 116 (shown in FIG. 1). Alternatively, the feeder actuator 200 may be joined to the control module 122 of the terminator 100 for controlling the operation of the feeder actuator 200.

During operation, the feeder actuator 200 rotates the lead screw 202 about an axis of rotation 205, and the rotational motion of the lead screw 202 is transferred to linear motion of the feeder carriage 204. For example, the feeder carriage 204 is moveable linearly between an advanced position, wherein the feeder carriage 204 is moved to a preset position in the direction of arrow D, and a retracted position, wherein the feeder carriage 204 is moved to a preset position in the direction of arrow E. In the advanced position, the terminals 110 are positioned in the crimping zone 106. In the retracted position, the feeder device 104 engages a new terminal for advancement. The feeder actuator 200 rotates the lead screw 202 in both a forward driving direction and a rearward driving direction. Optionally, in the forward driving direction, the feeder actuator 200 rotates the lead screw 202 in a clockwise direction, and in the rearward driving direction the feeder actuator 200 rotates the lead screw 202 in a counter-clockwise direction. Alternatively, in the forward driving direction, the feeder actuator 200 rotates the lead screw 202 in a counter-clockwise direction, and in the rearward driving direction the feeder actuator 200 rotates the lead screw 202 in a clockwise direction. When the lead screw 202 is operated in the forward driving direction, the feeder carriage 204 is moved in the direction of the advanced position. When the lead screw 202 is operated in the rearward driving direction, the feeder carriage 204 is moved in the direction of the retracted position. The amount of rotation of the lead screw 202 is controlled and may be programmable based on the particular application for the terminator 100, such as, for example, the size of the terminals 110 (shown in FIG. 1) or the spacing of the terminals 110. Optionally, the feeder device 104 may include a belt drive or a gear drive coupled between the feeder actuator 200 and the lead screw 202. In an alternative embodiment, the feeder carriage 204 may be rotated by the feeder actuator 200 to advance the terminals 110 to the crimping zone 106.

In an exemplary embodiment, the feeder device 104 includes a frame 206 having a front support plate 208 and a rear support plate 210. The front and rear support plates 208 and 210 are planar and extend parallel to one another. Each support plate 208 and 210 includes a front surface 212 and a rear surface 214. The rear support plate 210 supports the feeder actuator 200, and the feeder actuator 200 is positioned along a portion of the rear surface 214 of the rear support plate 210. The front support plate 208 supports a mounting bracket 216, and the mounting bracket 216 is positioned along the front surface 212 of the front support plate 208. The rear surface 214 of the front support plate 208 and the front surface of the rear support plate 210 face one another and are separated by a distance such that a gap 218 exists between the front and rear support plates 208 and 210. The lead screw 202 and the feeder carriage 204 are received in the gap 218. Optionally, the frame 206 includes a tube 220 extending between the front and rear support plates 208 and 210. The tube 220 may support the front and rear support plates 208 and 210 and maintain the spacing between the front and rear support plates 208 and 210. The tube 220 may also carry wires between the front and rear support plates 208 and 210, as will be described in more detail below.

The feeder carriage 204 includes a body 230 having a front end 232, a rear end 234, a top end 236, a bottom end 238, and sides 240 extending between each of the ends. Optionally, the feeder carriage 204 may be box-shaped. In an exemplary embodiment, the feeder carriage 204 includes a plurality of openings extending therethrough, such as an upper guide opening 242, a lower guide opening 244, a lead screw opening (not shown), and a sensor device opening 246. The openings extend generally between the front end 232 and the rear end 234 of the body 230. In one embodiment, the openings may be substantially aligned. In other embodiments, the openings may be off-set with respect to one another.

The upper guide opening 242 receives an upper bushing 248 and the lower guide opening receives a lower bushing 250. The upper bushing 248 receives an upper guide rail 252 and the lower bushing 250 receives a lower guide rail 254. The upper and lower guide rails 252 and 254 are received in the gap 218 and extend between the front and rear support plates 208 and 210. The upper and lower guide rails 252 and 254 support the feeder carriage 204 and define a path of travel for the feeder carriage 204. The upper and lower guide rails 252 and 254 support the front and rear support plates 208 and 210 and maintain the spacing between the front and rear support plates 208 and 210.

The feeder carriage 204 includes a lead screw nut 260 secured thereto. Optionally, the lead screw nut 260 may be integrally formed with the feeder carriage body 230. The lead screw nut 260 is aligned with the lead screw opening and threadably engages the lead screw 202. Rotational motion of the lead screw 202 is transferred to linear motion of the feeder carriage 204 by the threaded relationship between the lead screw 202 and the lead screw nut 260.

A feeding member assembly 270 is coupled to the feeder carriage 204 and carried by the feeder carriage 204 between the advanced position and the retracted position. The feeding member assembly 270 includes a mounting block 272 that is removably coupled to the side of the body 230 at the bottom end 238. Optionally, the mounting block 272 may be coupled directly to the bottom end 238 and may be substantially centered with respect to the sides 240 of the body 230. Alternatively, the mounting block 272 may be substantially centered with respect to the body 230. The feeding member assembly 270 also includes a terminal feeding member 274 removably coupled to the mounting block 272. The terminal feeding member 274 includes a tip 276 configured to engage the terminals 110 or the carrier strip for the terminals 110.

Optionally, the feeder device 104 may include a sensor device 280 for determining the linear position of the feeder carriage 204. The sensor device includes a sensor arm 282 extending within the gap 218 and positioned adjacent to the feeder carriage to determine the relative position of the feeder carriage 204 with respect to the feeder actuator 200. Optionally, the sensor arm 282 extends through the sensor device opening 246 of the body 230. The feeder carriage 204 is moveable along the sensor arm 282, and a signal representing the position of the feeder carriage 204 is transmitted to either the controller 203 for the feeder actuator 200 or to the control module 122 for the terminal crimping machine 100. The sensor device 280 thus provides feedback to the controller 203 for controlling the position of the feeder carriage 204. Alternatively, other types of sensor devices may be used to provide feedback to the controller 203 relating to the position of the feeder carriage 204, such as, for example, an optical sensing device, or other types of linear position sensors. As such, a closed loop feedback may be provided to the feeder device 104.

The cover 160 extends over the components of the feeder device 104 such as the feeder actuator 200 and the feeder carriage 204. Optionally, the cover 160 may be coupled to the front and rear support plates 208 and 210. The cover 160 includes a slot 284 in a bottom portion of the cover 160 to allow for linear movement of the feeder carriage 204. For example, the feeding member assembly 270 extends below the cover 160 and is accessible from outside of the cover 160. The feeding member assembly 270 moves along the slot 284 during operation of the feeder device 104. Optionally, other components of the feeder device 104 may be exposed outside the cover 160, such as the feeder actuator 200.

FIG. 5 illustrates a cross sectional view of the applicator 102 and the feeder device 104 taken generally along a plane extending through the sensor arm 282 shown in FIG. 4. The front and rear support plates 208 and 210 support the various components of the feeder device 104. For example, the rear support plate 210 supports the feeder actuator 200. The rear support plate 210 includes a housing portion 300 defining a cavity 302. A shaft portion 304 of the feeder actuator 200 is received in the cavity 302. A coupler 306 is also received in the cavity 302 and directly couples the shaft portion 304 to the lead screw 202. Alternatively, an intervening linkage may be provided between the shaft portion 304 and the lead screw 202, such as gears. Bearings 308 are provided between the lead screw 202 and each of the front and rear support plates 208 and 210 to facilitate rotation of the lead screw 202. The bearings 308 are positioned proximate a forward end 310 and a rearward end 312 of the lead screw 202. Alternatively, bushings may be used in place of bearings 308. FIG. 5 also illustrates the lead screw 202 extending through the lead screw opening, described above and now shown generally at 314. The lead screw nut 260 extends through the lead screw opening 314.

The sensor device 280 is also illustrated as being supported by each of the front and rear support plates 208 and 210. The sensor arm 282 extends through the sensor device opening 246 in the body 230 of the feeder carriage 204 and interacts with a sensor 316 also received within the sensor device opening 246.

The upper and lower guide rails 252 and 254 are supported by each of the front and rear support plates 208 and 210. Each guide rail 252 and 254 extends between a forward end 320 engaging the front support plate 208 and a rearward end 322 engaging the rear support plate 210. Optionally, the upper and lower guide rails 252 and 254 may be secured to the front and rear support plates 208 and 210 by fasteners such as screws. The upper and lower guide rails 252 and 254 also extend through the upper and lower bushings 248 and 250, respectively. The upper and lower bushings 248 and 250 slide along the upper and lower guide rails 252 and 254 during movement of the feeder carriage 104.

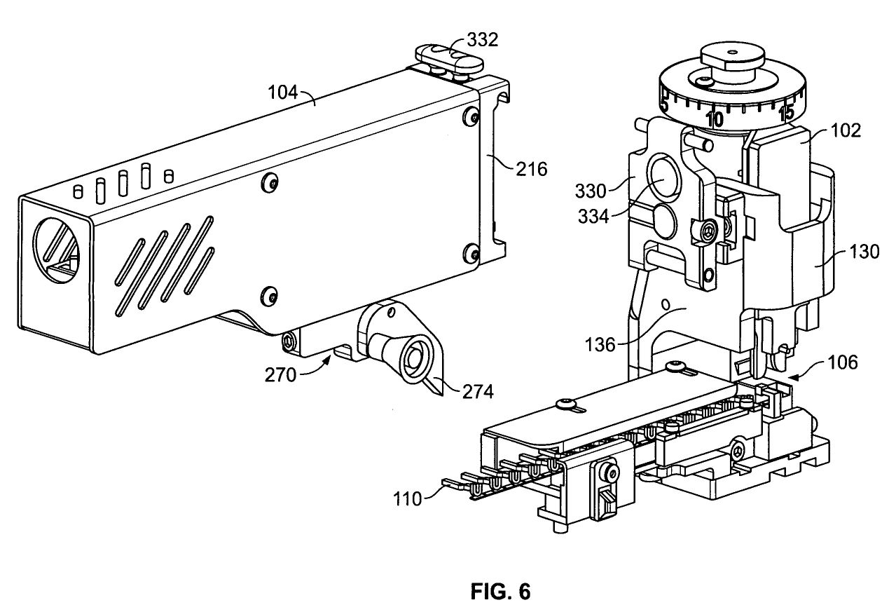

FIG. 6 illustrates a perspective view of the applicator 102 and the feeder device 104. The applicator 102 includes a mounting bracket 330 coupled to the rear 136 of the frame 130. During assembly, the mounting bracket 216 of the feeder device 104 is removably coupled to the mounting bracket 330 of the applicator 102. The applicator 102 thus supports the feeder device 104 generally above the terminals 110 such that the terminal feeding member 274 of the feeding member assembly 270 may engage the terminals 110 or the carrier strip for the terminals 110. Alternatively, the feeder device 104 may be coupled to another portion of the terminator 100 (shown in FIG. 1) such that applicators 102 may be interchanged in the terminator 100 without moving the feeder device 104. Optionally, the feeder device 104 includes a release 332 to release or detach the feeder device 104 from the applicator 102 or the terminator 100. The cost of the applicator 102, and thus the terminator 100, may be reduced because a single feeder device 104 may be interchangeable with various applicators 102.

Optionally, the applicator 102 may include a memory device 334 coupled to the mounting bracket 330. The memory device 334 may include information, such as feeding parameters based on the type of applicator 102, relating to a feed stroke for the feeder device 104. The feeder device 104 may be configured to read the information from the memory device 334, or the information may be otherwise transmitted or transferred to the feeder device 104 to control the feed stroke and properly position the terminals 110 within the crimping zone 106. In one embodiment, the feeder device 104 includes a reader/writer device 336 (shown in FIG. 4) that reads the information from the memory device 334. The memory device 334 transmits the information to controller 203 via a wire (not shown) running through tube 220 (shown in FIG. 4). The feeder device 104 may automatically adjust the feed stroke without a user's adjustment based on the information. In one embodiment, the memory device 334 is a RAM-type memory device that is readable and writable by the controller 203. Alternatively, the memory device may be a radio frequency identification tag.

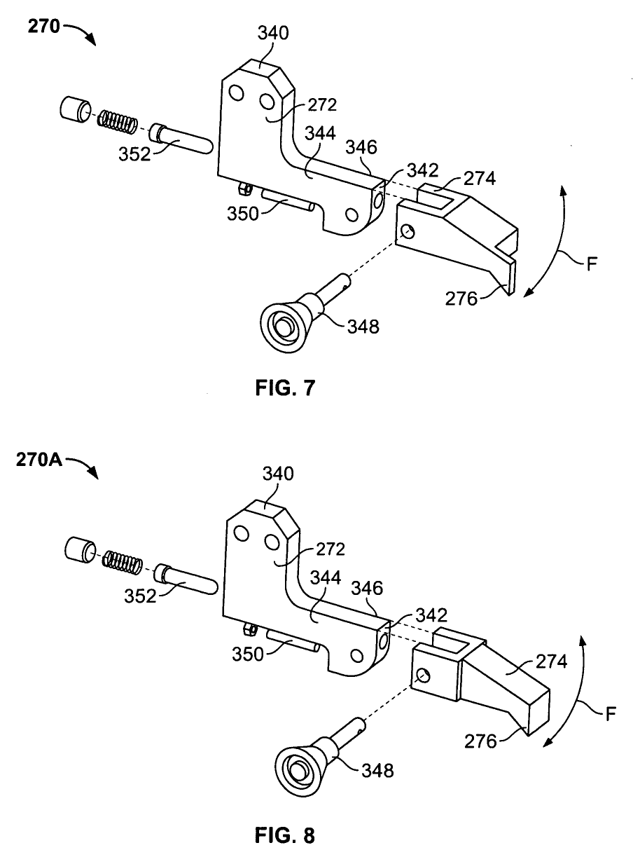

FIG. 7 illustrates the feeding member assembly 270 for the feeder device 104 (shown in FIGS. 1-6). The mounting block 272 extends between a mounting end 340 and a mating end 342 and includes opposed side surfaces 344 and 346. The mounting end 340 is configured to be attached to the feeder carriage 204 (shown in FIG. 4) as described above. The terminal feeding member 274 is removably coupled to the mating end 342 of the mounting block 272. Optionally, a fastener 348 is used to couple the terminal feeding member 274 to the mounting block 272. The fastener 348 may be removed to remove the terminal feeding member 274 from the mounting block 272. In an exemplary embodiment, the terminal feeding member 274 is rotatably coupled to the mounting block 272 and the terminal feeding member 274 rotates generally in the direction of arrow F. Optionally, the feeding member assembly 270 may include a stopper 350 to limit a range of motion of the terminal feeding member 274. The feeding member assembly 270 may also include a pusher 352 that biases the terminal feeding member 274 in the direction of the stopper 350. For example, in one embodiment, the pusher 352 is spring loaded against the terminal feeding member 274.

The terminal feeding member 274 illustrated in FIG. 7 is utilized in a side-feed type applicator 102, such as the applicator 102 shown in FIG. 2. The side-feed type applicator accepts terminals 110 (shown in FIG. 1) on a carrier strip. The tip 276 of the side-feed type terminal feeding member 274 is sized and shaped to fit into holes provided in the carrier strip for the terminals 110. The tip 276 is also positioned at an edge of the terminal feeding member 274.

FIG. 8 illustrates another feeding member assembly 270A for the feeder device 104. The feeding member assembly 270A is similar to the feeding member assembly 270 shown in FIG. 7, and as such, like reference numerals will be used to identify like features. The terminal feeding member 274 is removably coupled to the mounting block 272. Optionally, a fastener 348 is used to couple the terminal feeding member 274 to the mounting block 272. The terminal feeding member 274 illustrated in FIG. 8 is utilized in an end-feed type applicator 102, such as the applicator 102A shown in FIG. 3. The end-feed type applicator accepts terminals 110A (shown in FIG. 3) arranged end-to-end. The tip 276 of the end-feed type terminal feeding member 274 is sized and shaped to engage an upwardly projecting portion of the terminals 11A.

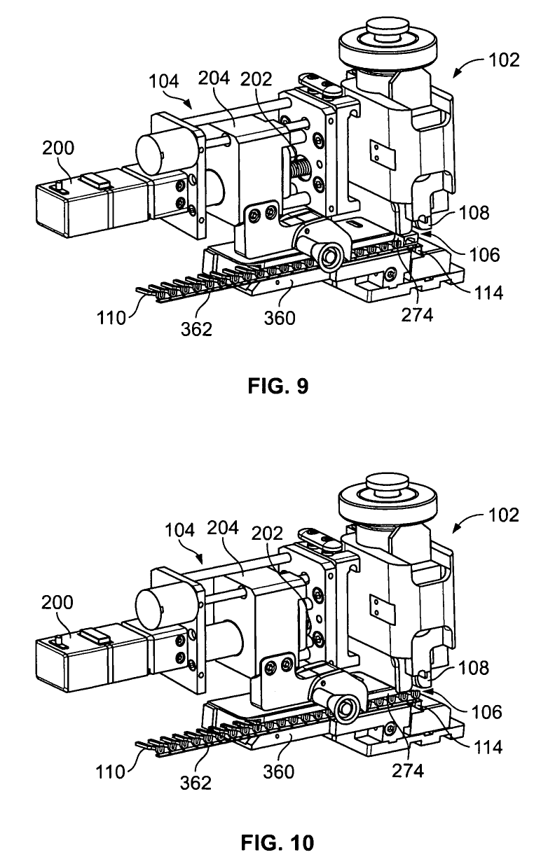

The operation of the terminator 100 will be discussed with reference to FIGS. 9 and 10. FIG. 9 illustrates a perspective view of the feeder device 104 in a retracted position. FIG. 10 illustrates a perspective view of the feeder device 104 in an advanced position. In each of FIGS. 9 and 10, the cover 160 (shown in FIG. 4) of the feeder device 104 has been removed for clarity.

In operation, the terminals 110 are supplied to a base 360 from a reel (not shown). The base 360 is positioned adjacent to the applicator 102 and generally below the feeder device 104. Optionally, a drag bar (not shown) may be used to securely position the terminals 110 with respect to the base 360 and to hold the terminals in tension to resist forward motion of the terminals toward the crimping zone 106. The terminals 110 may be side-feed terminals or end-feed terminals depending on the particular application. FIGS. 9 and 10 illustrate side-feed terminals having a carrier strip.

As illustrated in FIG. 9, the terminals 110 and the feeder device 104 are in a retracted position. In the retracted position, no terminal is located within the crimping zone 106 of the applicator 102. Additionally, in the retracted position, the terminal feeding member 274 of the feeder device 104 engages a hole 362 of the carrier strip. The terminal feeding member 274 is biased downward into the hole by the pusher 352 (shown in FIG. 7). Additionally, the terminal feeding member 274 maintains engagement with the carrier strip during the feeding stroke via the pusher 352.

In operation, the feeder device 104 transfers the terminals 110 to the advanced position, shown in FIG. 10, wherein one of the terminals 110 is positioned in the crimping zone 106 directly between the anvil 118 and the crimp tooling 108. The feeder device 104 transfers the terminals 110 independently of the operation of the applicator 102. For example, the feeder actuator 200 is operated and rotates the lead screw 202 in the forward driving direction for a predetermined amount of time or a predetermined amount of revolutions. The rotation of the lead screw 202 transfers the feeder carriage 204 a corresponding predetermined distance from the retracted position to the advanced position. The feeder actuator 200 then rotates the lead screw 202 in the rearward driving direction for a predetermined amount of time or a predetermined amount of revolutions. The rotation of the lead screw 202 transfers the feeder carriage 204 a corresponding predetermined distance from the advanced position to the retracted position.

In an exemplary embodiment, a feed stroke of the feeder device 104 is accomplished independently of a crimping stroke of the applicator 102. A feed stroke is defined as the transfer of the feeder carriage 204 from the retracted position, to the advanced position, and back to the retracted position. A crimping stroke is defined as the transfer of the crimp tooling 108 from a retracted position, to a crimp position, and back to the retracted position. In one embodiment, the feeder device 204 may advance multiple terminals to the crimping zone 106 during a single feed stroke, wherein one terminal is presented to the crimp zone 106 during each crimp stroke. The applicator 102 thus may have multiple crimp strokes for each feed stroke.

Optionally, the feeder actuator 200 may control the position of the feeder carriage 204 at any given time. The position of the feeder carriage 204 over time defines a motion profile of the feeder carriage 204, and the feeder actuator 200 controls the motion profile. The motion profile may be controlled by defining a starting position of the feeder carriage 204, controlling a stopping position of the feeder carriage 204, controlling a speed of the feeder carriage 204, controlling an acceleration or deceleration of the feeder carriage 204, and the like. These variables may be adjusted or altered during the feed stroke to provide a controlled motion profile and a more consistent feed position. For example, the speed of the feeder carriage 204 may be slowed near the limits of the range of motion of the feeder carriage 204. The feeder carriage 204 may thus have controlled acceleration from, and controlled deceleration toward, the retracted position and/or the advanced position. The feeder carriage 204 may have a different speed during the advancing portion of the feed stroke than the retracting portion of the feed stroke. The speed may be varied by varying the speed of the feeder actuator 200 and the speed of rotation of the lead screw 202. Additionally, the speed of the feeder carriage 204 may be varied independently of a crimping stroke of the applicator. For example, the crimp stroke of the applicator 102 may have a constant speed, but the speed of the feed stroke of the feeder carriage 204 may be varied. As such, the feed stroke is operated independently of the crimp stroke. Additionally, as indicated above, the motion profile may include multiple stopping positions along the feed stroke such that multiple terminals 110 may be feed to the termination zone 106 during a single feed stroke. The acceleration from and deceleration to each stopping position may be controlled.

In an exemplary embodiment, the feed stroke is programmable and controlled by controller 203. For example, the retracted position and the advanced position may be determined and/or adjusted based on inputs to the controller 203, such as by pushing advance or retract buttons on a computer or dials on the feeder device 104 or terminator 100. Manual or mechanical adjustments by a user to linkages between the applicator 102 and feeder device 104 are not required. Set up time and down time are thus reduced. Additionally, the retracted position and the advanced position may be determined based on the type of applicator 102 used. For example, the memory device 334 (shown in FIG. 6) may provide information to the controller to define the advanced and retracted positions of the feeder carriage 204.

Optionally, a monitoring system (not shown) may be provided to provide feedback to the controller relating to the position of the terminals with respect to the crimping zone to automatically adjust the feed stroke. For example, a camera (not shown) or optical sensing device may be provided to determine the advanced and/or retracted positions. Adjustments to the advanced or retracted positions may be made based on inputs from the camera. As such, a closed loop feedback may be provided to the feeder device 104.

A terminator 100 is thus provided having a feeder actuator 200 controlled feeder device 104 that reduces setup time since the feed stroke and the terminal position may be programmable. Thus, unlike current systems that require the operator to use tools and adjusting linkage, the operator simply pushes advance or retract buttons on the feed device to change the stroke or position. Secondly, the cost of the overall crimping system may be reduced because each terminator 100 will require only one feeder device 104 since the feeder device 104 is removable from the applicator 102. Additionally, since no linkage mechanism is required on the applicator 102, the cost of an applicator is reduced. Finally, the feeder device provides flexibility in the rate and final position of terminal feeding to improve crimp quality. The feeder actuator 200 is programmed to provide a slow and controlled acceleration and deceleration profile thereby providing more consistent feed position.

While the invention has been described in terms of various specific embodiments, those skilled in the art will recognize that the invention can be practiced with modification within the spirit and scope of the claims.

What is claimed is:

1. A feeder device configured to be used with a termination machine having a termination tool, the device comprising:
a frame configured to be located proximate to a termination zone of the termination tool;
a feeder carriage mounted to the frame, the feeder carriage being movable in a terminal feeding direction to an advanced position; and
an electric actuator mounted to the frame and joined to the feeder carriage, the actuator driving the feeder carriage in the terminal feeding direction to the advanced position to locate a terminal at the termination zone.

2. The feeder device of claim 1, further comprising a terminal feeding member configured to engage one of a terminal and a carrier strip for a terminal, the terminal feeding member being carried by the feeder carriage, and the terminal feeding member being configured to advance the terminals toward the termination zone as the feeder carriage is moved in the terminal feeding direction.

3. The feeder device of claim 1, further comprising a lead screw coupled to the actuator, the feeder carriage threadably coupled to the lead screw such that, as the actuator rotates the lead screw, the feeder carriage moves linearly along the terminal feeding direction.

4. The feeder device of claim 1, the frame further comprising guide rails, the feeder carriage receiving the guide rails and movable along the guide rails between the advanced position and a retracted position.

5. The feeder device of claim 1, further comprising a first terminal feeding member and a second terminal feeding member, the first terminal feeding member configured to advance a first type of terminal and the second terminal feeding member configured to advance a second type of terminal.

6. The feeder device of claim 1, further comprising a controller, wherein the controller is programmable to control the operation of the electric actuator.

7. The feeder device of claim 1, further comprising:
a controller for controlling an operation of the electric actuator; and
a sensor for determining a position of the feeder carriage, wherein the controller operates the electric actuator based on the position of the feeder carriage.

8. A termination machine comprising:
a termination tool having termination tooling configured to terminate a terminal to a wire in a termination zone;
a terminator actuator driving the termination tooling to and from the termination zone;
a feeder device positioned proximate to the termination tool, the feeder device having a terminal feeding member configured to successively feed terminals to the termination zone; and
an electric feeder actuator driving the terminal feeding member in a terminal feeding direction, wherein the terminals are fed to the termination zone as the terminal feeding member is moved in the terminal feeding direction.

9. The termination machine of claim 8, the feeder device further comprising a bracket to removably couple the feeder device to the termination tool.

10. The termination machine of claim 8, wherein the feeder device is fixed to a frame of the termination machine.

11. The termination machine of claim 8, further comprising a control module for coordinating the operation of the terminator actuator and the feeder actuator.

12. The termination machine of claim 8, wherein the feeder actuator moves the terminal feeding member along a controlled motion profile.

13. A termination system comprising:
a termination tool having termination tooling configured to terminate a terminal to a wire in a termination zone; and
a feeder device positioned proximate to the termination tool, the feeder device including a frame, a feeder carriage mounted to the frame, and an electric feeder actuator mounted to the frame and joined to the feeder carriage, the feeder actuator driving the feeder carriage in a terminal feeding direction to an advanced position to locate a terminal at the termination zone.

14. The termination system of claim 13, further comprising a terminal feeding member configured to engage one of a terminal and a carrier strip for a terminal, the terminal feeding member being carried by the feeder carriage and being configured to advance the terminals toward the termination zone as the feeder carriage is moved in the terminal feeding direction.

15. The termination system of claim 13, wherein the feeder device is removably coupled to the termination tool.

16. The termination system of claim 13, the termination tooling moveable along a termination stroke, the feeder device configured to successively feed terminals to the termination zone synchronously with the termination stroke.

17. The termination system of claim 13, wherein the feeder actuator moves the terminal feeding member along a controlled motion profile.

18. The termination system of claim 13, further comprising a first termination tool and a second termination tool, the first termination tool configured to terminate a first type of terminal and the second termination tool configured to terminate a second type of terminal, the termination system further comprising a frame, the first termination tool mountable to the frame and the second termination tool mountable to the frame, wherein the first termination tool is configured to be removed from the frame and replaced by the second termination tool, the feeder device operable with both the first termination tool and the second termination tool.

19. The termination system of claim 13, further comprising a control module operatively coupled to the termination tool and the feeder device, the control module configured to operate the termination tool in a termination operation and the control module configured to operate the feeder device in a feeding operation, wherein the control module coordinates the termination operation and the feeding operation.

20. A termination machine comprising:
a termination tool having termination tooling configured to terminate a terminal to a wire in a termination zone by driving the termination tooling to and from the termination zone, the termination tool configured to receive terminals from a programmable feeder device having a feeder actuator driving a terminal feeding member in a terminal feeding direction, wherein the terminals are fed to the termination zone as the terminal feeding member is moved in the terminal feeding direction.

21. The termination machine of claim 20, wherein the termination tool comprises a mounting bracket configured to support the feeder device.

22. The termination machine of claim 20, the termination tooling moveable along a termination stroke, the feeder device configured to successively feed terminals to the termination zone synchronously with the termination stroke.

23. The termination machine of claim 20, wherein the termination tool comprises a mounting bracket configured to support the feeder device, the mounting bracket variably positionable to orient the feeder device relative to the terminal.
